(19) United States
(12) Patent Application Publication
(10) Pub. No.: US 2003/0163336 A1
(43) Pub. Date: Aug. 28, 2003

(54) Integration method for different information platforms in a decision-making system

(76) Inventors: Hung Liang Chiu, Taipei (TW); Ta Te Lin, Taipei (TW); Mhing Fen Lee, Taipei (TW); Yi Ming Liao, Taipei (TW); Win Chee Yu, Taipei (TW); Hui Mei Kuo, Taipei (TW)

Correspondence Address: JACOBSON HOLMAN PLLC, 400 SEVENTH STREET N.W., SUITE 600, WASHINGTON, DC, 20004, US

(21) Appl. No.: 10/080,553

(22) Filed: Feb. 25, 2002

(51) Int. Cl. G06F 17/60

(52) U.S. Cl. 705/1

(57) ABSTRACT

An integration method for different information platforms in a decision-making system is proposed to solve the problem of being unable to integrate information among different platforms in the existing decision-making systems of the manufacturing industry. All information is integrated in a database and then distributed to users through a network and E-mail. The invention includes at least the following steps: the enterprise downloads at least one set of data from an information platform to a shared folder; a database server integrates the data in the shared folder; the computed data are moved to an integration platform; the enterprise selects a particular method to distribute the integrated data; and the user receives the data.

### BACKGROUND OF THE INVENTION

1. Field of the Invention

The invention relates to an information integration method. More particularly, the invention relates to a method for integrating different information platforms through a decision-making system that is applied to enterprise group operations.

2. Related Art

With expanding information technologies and enterprise scales, traditional concept of materials distribution management cannot satisfy the needs by modern businesses. Therefore, an SCM (supply chain management) by integrating all sorts of data and concerns is invented. The supply chain is mainly focused on material distributions and warehousing. However, the platforms used by different companies in the supply chain may be different. In addition, current information platform development is narrowly discussing how to expand its function without paying attention to integrating data in different information platforms. With reference to FIG. 1, a plurality of information platforms 10a˜10n is provided for a plurality of users 50a˜50n to use. The same information platform in 10a˜10n is often shared by different users 50a˜50n. For example, the information platform 10b is used by the users 50a and 50b together; but they also simultaneously use other information platforms 10a˜10n. When the user wants to make data transfer or transmission, incompatibility resulted from different data formats often disallows information sharing and causes business losses.

Accordingly, it is an important subject to unify information in an enterprise and integrate different information platforms of a group decision-making system.

### SUMMARY OF THE INVENTION

In view of the foregoing, the invention provides an integration method for different information platforms in a decision-making system. A major objective of the invention is to solve the problem of having too many information platforms while being unable to effectively integrate them in normal enterprises. Using the disclosed method, related data in different information platforms can be integrated and organized through operations among the databases. An integration platform is employed to manage the data, to establish communications among data flows, and to avoid unnecessary data waste or misuses. Moreover, through the disclosed data transmission method the data format at a user end can be readily converted into the one that the enterprise can recognize.

The method includes at least the following steps: the enterprise downloads at least one set of data from an information platform to a shared folder; a database server integrates the data in the shared folder; the computed data are moved to an integration platform; the enterprise selects a particular method to distribute the integrated data; and the user receives the data.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the prior art;

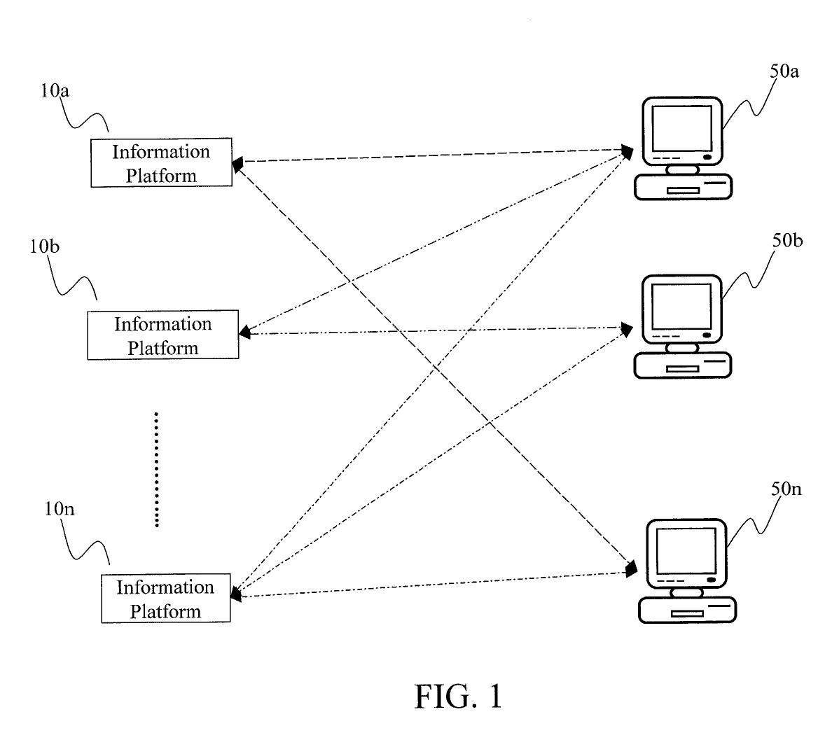

FIG. 2-a shows a schematic structure of the disclosed integration method;

FIG. 2-b shows a schematic structure of the disclosed integration method;

FIG. 3-a is a flowchart of the disclosed integration method; and

FIG. 3-b is a flowchart of the disclosed integration method.

### DETAILED DESCRIPTION OF THE INVENTION

The invention provides a method to integrate information among different information platforms in decision-making systems, particularly for the SCM (Supply Chain Management) and ERP (Enterprise Resource Planning) currently proposed in the market. Its objectives are to make effective use and management of enterprise resources, to modernize and integrate the processing procedures for data exchanges in different platforms, and to lower the operation costs of the company.

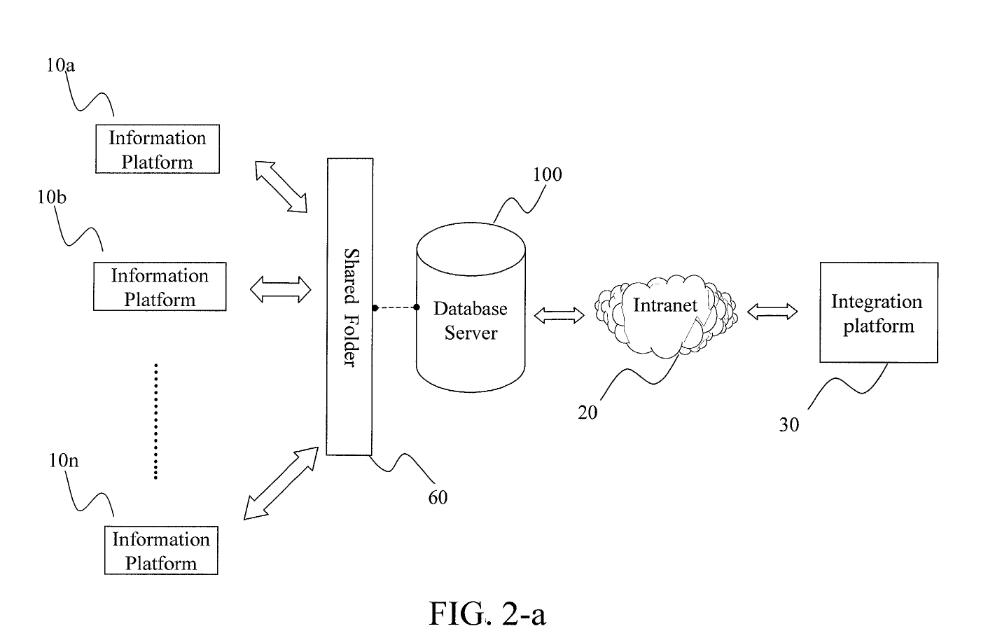

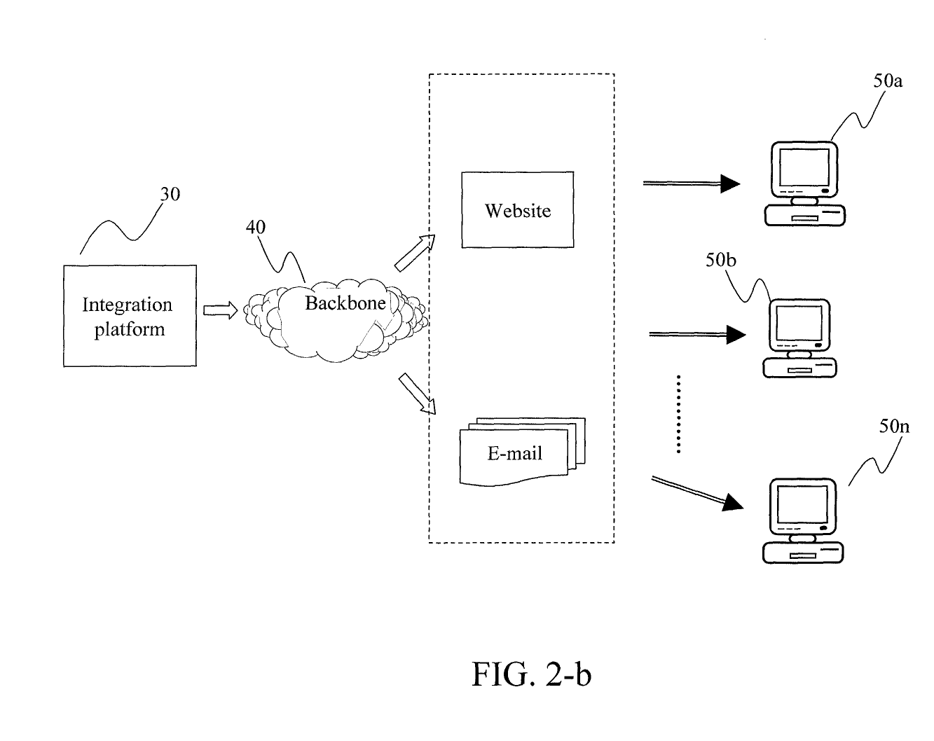

This specification uses a preferred embodiment to demonstrate the feasibility of the invention. Please refer to FIGS. 2-a and 2-b for the system structure of the invention. As shown in FIG. 2-a, the invention builds this system structure into an ERP server of the enterprise, which has a plurality of information platforms 10a˜10n. All data are stored in a shared folder 60. A database server 100 is provided to connect with an integration platform 30 through an Intranet 20, which may be an Ethernet. As shown in FIG. 2-b, the integration platform 30 is connected to the users 50a˜50n through a backbone 40. The backbone 40 is used for data transmission and refers to any network structure and style with the functions of communications and data transmissions. The database 100 may be an SQL (structured query language) server.

The information can be distributed by the integration platform. It can also be posted in a website outside the corporate, which is installed on a third-party information platform. The invention further provides a data conversion model for the information distribution. The concept of CTO (Configure To Order) is used to achieve the objective of network data transmission. Different tables and fields are provided for different needs so that users can more efficiently and easily obtain desired data.

The disclosed method put the conventional concept of data transmission over the World Wide Web. Integration of different data types and a real-time transmission function are applied between the users and the enterprise using technologies of the ERP, the SCM and the third-party information mediator. The users do not receive data passively, but can transmit and receive data effectively according to the needs. A data transmission unit is provided at the third-party between the users and the enterprise for converting data formats.

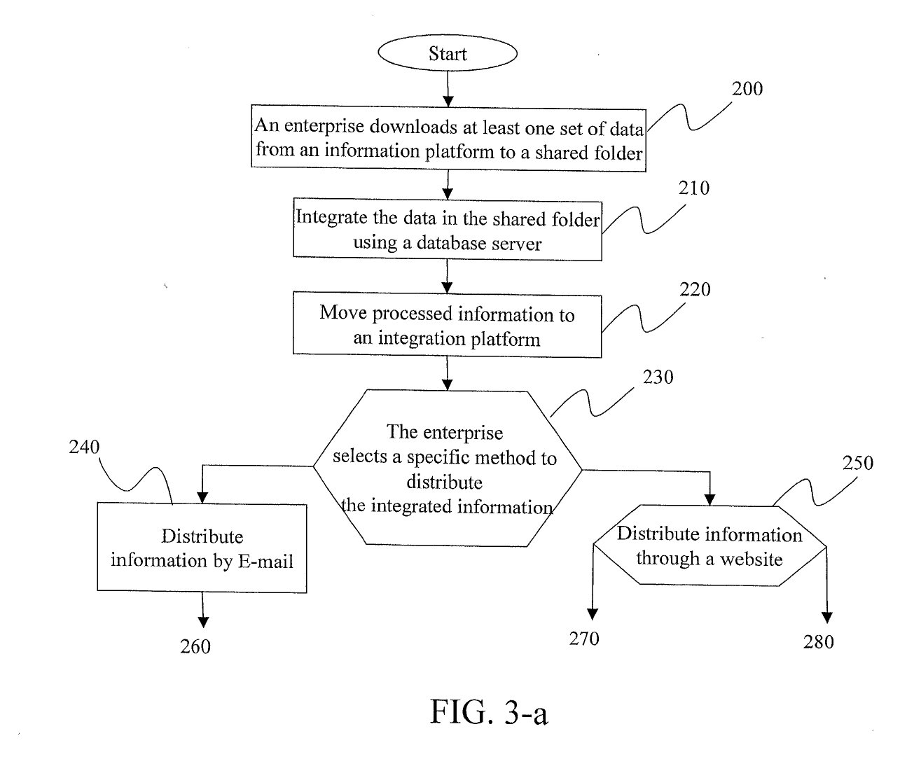

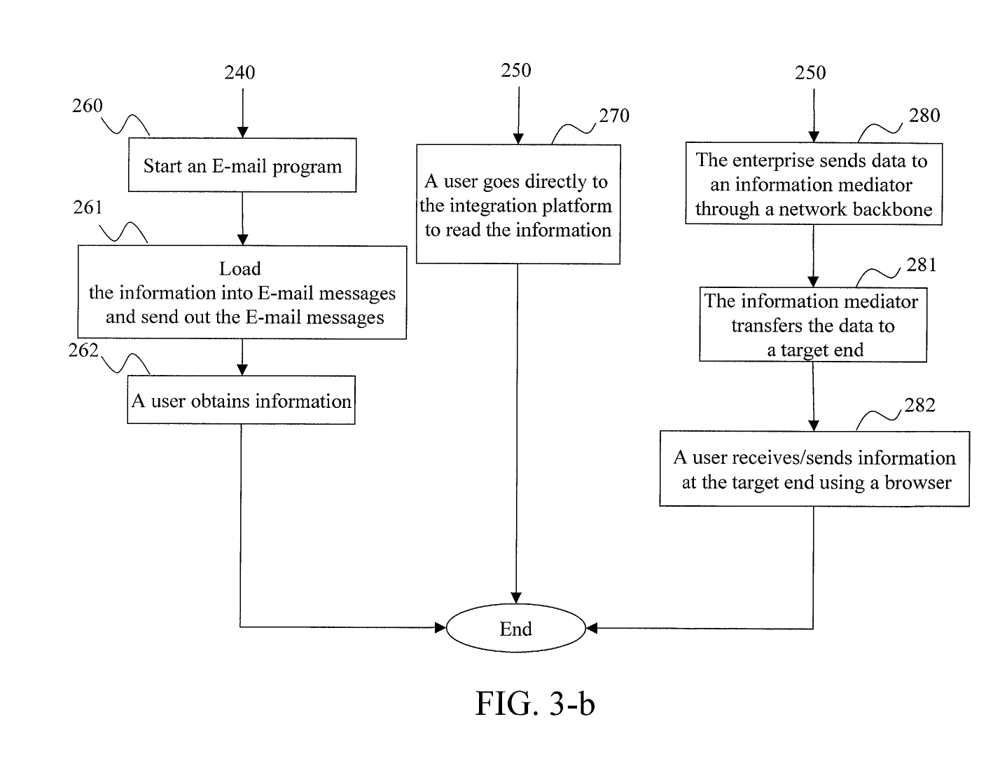

With reference to FIGS. 3-a and 3-b, an enterprise first downloads at least one set of data from information platforms 10a˜10n to a shared folder 60 (step 200). A database server 100 then integrates the data in the shared folder 60 (step 210). The processed data are moved to an integration platform 30 (step 220). Afterwards, the enterprise selects a particular method to distribute the integrated data (step 230). One method is to distribute information via Email (step 240). Another method is to distribute information through a website (step 250). As shown in FIG. 3-b, if one selects to distribute information via E-mail, then an E-mail program starts (step 260) to load information into E-mail messages and to send out the E-mail messages (step 261). Finally, a user obtains the information (step 262) and the procedure finishes. If one selects to distribute information through a website, there are still two possibilities. One is via an internal website, and the other is via an external website. If one selects the internal website, then a user goes to the integration platform 30 and directly reads the information (step 270), then the procedure terminates. If one selects the external website, then the enterprise transmits the data through a backbone to an information mediator (step 280). An information converter is then used to make data format conversions. The information mediator then transmits the data to a target end (step 281). Finally, a user uses a browser to receive the information from the target end (step 282), and the procedure terminates.

The above-mentioned decision-making system is used to filter and select various kinds of data inside and outside the enterprise, and to give related managers and users warnings about how the real situation deviates from the plan. The different information platforms are those incompatible among themselves while having independent operating platforms.

The above-mentioned target end refers to a platform that is provided by the information mediator and stores data of the users and the enterprise.

Before transmitting data from the enterprise to the information mediator, a data converter and a data conversion engine are installed between the enterprise and the information mediator. The data conversion engine belongs to the data converter. When data are transmitted to the information mediator, they go through the data converter and link to a function database through the data conversion engine. The data are then converted by the function database into different formats required by different suppliers. According to the data format conversion method, any data format required by the supplier can be properly obtained, achieving the goal of CTO data transmissions.

The above-mentioned data format conversion using a data converter utilizes the CTO concept to achieve network data transmissions and to setup different tables and fields according to user's different needs.

The target end is a platform provided by the information mediator and stores data of the supplier and the enterprise.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of integrating different information platforms in a decision-making system of the manufacturing industry to use a database server provided by an enterprise to integrate data of different information platforms and to transmit the data to a user through the Internet connection, the method comprising the steps of:
the enterprise downloading at least one set of data from an information platform to a shared folder;
integrating the data in the shared folder using a database server;
moving the processed data to an integration platform;
the enterprise distributing the integrated information; and
the user receiving the information.

2. The method of claim 1, wherein the database server and the integration platform are connected through an enterprise Intranet which is an Ethernet.

3. The method of claim 1, wherein the step of transmitting information from the enterprise to the user is achieved through a network backbone.

4. The method of claim 3, wherein the network backbone is used for data transmissions and refers to a network structure with the functions of communications and data transmissions.

5. The method of claim 1, wherein the database server is an SQL (structured query language) server.

6. The method of claim 1, wherein the decision-making system is used to select various information inside and outside the enterprise, to notify the user how the real situation deviates from the original plan, and to send out warnings to each relevant administrator.

7. The method of claim 1, wherein the different information platforms refer to incompatible information platforms with independent operating systems.

8. The method of claim 1, wherein the distribution of the integrated information is achieved using a method selected from the group consisting of an E-mail mode and a website mode.

9. The method of claim 8, wherein the E-mail mode for distributing the integrated information further comprises the steps of:
starting an E-mail program;
loading the integrated information into E-mail messages and sending out the Email messages; and
a user obtaining the integrated information.

10. The method of claim 8, wherein the website mode for distributing the integrated information further contains the two choices of distributing through an internal website and distributing through an external website.

11. The method of claim 10, wherein with the choice of distributing the integrated information through an internal website users directly read the information from the integration platform.

12. The method of claim 10, wherein distributing the integrated information through an external website further comprises the steps of:
the enterprise transmitting the data to an information mediator through a network backbone;
the information mediator further transferring the data to a target end; and
the user receiving/sending data at the target end using a browser.

13. The method of claim 12, wherein the step of the enterprise transmitting the data to an information mediator through a network backbone performs data format conversions using a data converter.

14. The method of claim 13, wherein the data converter utilizes the CTO (customer to order) concept to achieve network data transmissions and the setup of different tables and fields according to different user needs.

15. The method of claim 12, wherein the target end is a platform provided by the information mediator and stores data of the users and the enterprise.
